(19) United States
(12) Patent Application Publication
(10) Pub. No.: US 2025/0054102 A1
(43) Pub. Date: Feb. 13, 2025

(54) IMAGE PROCESSING APPARATUS, IMAGE PROCESSING METHOD, AND IMAGE CAPTURE APPARATUS

(71) Applicant: CANON KABUSHIKI KAISHA, Tokyo (JP)

(72) Inventor: RYO SHIOTA, Kanagawa (JP)

(21) Appl. No.: 18/791,627

(22) Filed: Aug. 1, 2024

(30) Foreign Application Priority Data
Aug. 8, 2023 (JP) 2023-129515

(51) Int. Cl. G06T 3/4053; H04N 23/80

(52) U.S. Cl. CPC G06T 3/4053; H04N 23/80

(57) ABSTRACT

An image processing apparatus obtains a plurality of frames of first images, wherein the first images differ from each other in viewpoint. The apparatus generates one frame of second image having a higher resolution than the first images by combining the plurality of frames of first images, and generates a third image having a same resolution as the second image from one of the plurality of frames of first images. The apparatus detects a changed area that has changed among the plurality of frames of first images and further generates a fourth image, as a high-resolution image based on the plurality of frames of first images, from the second image and an area of the third image corresponding to an area of the second image corresponding to the changed area.

### BACKGROUND OF THE INVENTION

### Field of the Invention

The present invention relates to an image processing apparatus, an image processing method, and an image capture apparatus, and particularly to a technique to increase the resolution of an image (the number of pixels that constitute the image) with use of image composition.

### Description of the Related Art

A technique has been known that allows a digital camera including an image sensor that can be changed in position to generate a still image of a resolution exceeding the number of pixels in the image sensor by combining a plurality of frames of still images with positional differences smaller than a pixel pitch (Japanese Patent Laid-Open No. 2012-226489).

When a plurality of frames of still images with positional differences are combined, the areas that exhibit changes in position and brightness between frames give an unnatural impression in a composite image. This places a significant restriction on subjects and scenes for which intended composite images can be obtained.

### SUMMARY OF THE INVENTION

The present invention provides, in one embodiment thereof, an image processing apparatus that can improve the aforementioned issues of a technique to increase the resolution of an image with use of image composition.

According to an aspect of the present invention, there is provided an image processing apparatus comprising: one or more processors that execute a program stored in a memory and thereby function as: an obtainment unit that obtains a plurality of frames of first images, wherein the first images differ from each other in viewpoint; a generation unit that generates one frame of second image having a higher resolution than the first images by combining the plurality of frames of first images, and generates a third image having a same resolution as the second image from one of the plurality of frames of first images; and a detection unit that detects a changed area that has changed among the plurality of frames of first images, wherein the generation unit further generates a fourth image, as a high-resolution image based on the plurality of frames of first images, from the second image and an area of the third image corresponding to an area of the second image corresponding to the changed area.

According to another aspect of the present invention, there is provided an image processing method executed by an image processing apparatus, the image processing method comprising: obtaining a plurality of frames of first images, wherein the first images differ from each other in viewpoint; generating one frame of second image having a higher resolution than the first images by combining the plurality of frames of first images; generating a third image having a same resolution as the second image from one of the plurality of frames of first images; detecting a changed area that has changed among the plurality of frames of first images; and generating a fourth image, as a high-resolution image based on the plurality of frames of first images, from the second image and an area of the third image corresponding to an area of the second image corresponding to the changed area.

According to further aspect of the present invention, there is provided an image capture apparatus, comprising: an image sensor; and an image processing apparatus, wherein the image processing apparatus comprising: one or more processors that execute a program stored in a memory and thereby function as: an obtainment unit that obtains a plurality of frames of first images, wherein the first images have been shot at different viewpoints with use of the image sensor; a generation unit that generates one frame of second image having a higher resolution than the first images by combining the plurality of frames of first images, and generates a third image having a same resolution as the second image from one of the plurality of frames of first images; and a detection unit that detects a changed area that has changed among the plurality of frames of first images, wherein the generation unit further generates a fourth image, as a high-resolution image based on the plurality of frames of first images, from the second image and an area of the third image corresponding to an area of the second image corresponding to the changed area.

Further features of the present invention will become apparent from the following description of exemplary embodiments (with reference to the attached drawings).

### BRIEF DESCRIPTION OF THE DRAWINGS

FIG. 1 is a block diagram showing an exemplary functional configuration of a digital camera as one example of an image processing apparatus according to an embodiment.

FIG. 2 is a flowchart related to processing for increasing the resolution according to an embodiment.

FIG. 3 is a schematic diagram showing examples of a plurality of frames of low-resolution images including a change area.

FIG. 4 is a schematic diagram showing a high-resolution image obtained by combining a plurality of frames of low-resolution images.

FIG. 5 is a schematic diagram of a high-resolution image obtained from one frame of low-resolution image.

FIG. 6 is a schematic diagram showing an example of a change area map.

FIG. 7 is a schematic diagram showing an example of a high-resolution image that is obtained ultimately.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

Note that the following embodiment will be described in relation to a case where the present invention is embodied on an image capture apparatus (a digital camera). However, an image capture function is not indispensable in the present invention. The present invention can be embodied on any electronic devices capable of handling image data. Such electronic devices include not only an image capture apparatus, but also a computer device (a personal computer, a tablet computer, a media player, a PDA, or the like), a smartphone, a game device, a robot, a drone, and a driving recorder. These are examples, and the present invention can also be embodied on other electronic devices.

### First Embodiment

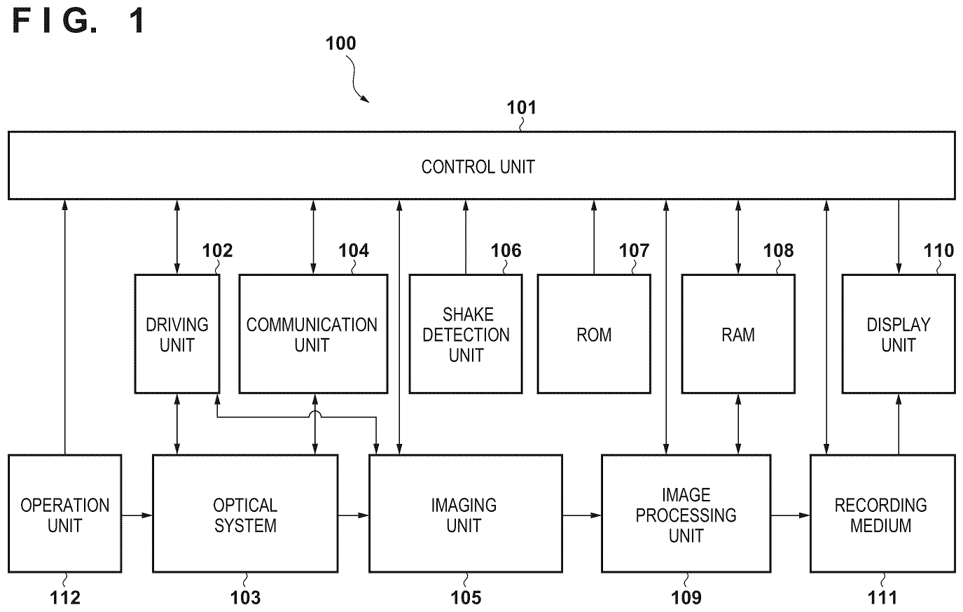

FIG. 1 is a block diagram showing an example of a basic functional configuration of a digital camera 100 as one example of an image processing apparatus according to a first embodiment of the present invention. Each functional block of the digital camera 100 can be implemented by software or a combination of software and hardware, except for components that apparently can be realized only by hardware (e.g., lenses and an image sensor included in an optical system 103, among others). For example, functional blocks may be realized by dedicated hardware, such as an ASIC. Furthermore, functional blocks may be realized by a processor, such as a CPU, executing a program stored in a memory. Note that a plurality of functional blocks may be realized by the same constituent (e.g., one ASIC). In addition, hardware that realizes a part of the functions of a certain functional block may be included in hardware that realizes another functional block.

A control unit 101 includes one or more processors (a CPU, an MPU, and the like) that can execute a program, reads the program stored in, for example, a ROM 107 into a RAM 108, and executes the program with use of the processor(s). The control unit 101 controls the operations of each functional block of the digital camera 100 and realizes the functions of the digital camera 100 by executing the program. Also, the control unit 101 executes automatic focus detection (AF), automatic exposure control (AE), and control on the operations of the optical system 103 and an imaging unit 105 in accordance with the results of AF and AE.

The ROM 107 is a rewritable nonvolatile memory, and stores the program executed by the control unit 101, various types of setting values of the digital camera 100, image data (GUI data) for a menu screen and an on-screen display (OSD), and so forth.

The RAM 108 is used as a main memory for the control unit 101, a buffer that temporarily stores captured image data, a working memory for an image processing unit 109, and so forth. Also, a part of the RAM 108 may be used as a video memory that stores image data for display.

The optical system 103 includes a plurality of lenses including movable lenses, a shutter, a diaphragm, and the like. The movable lenses include a focusing lens for adjusting the focusing distance of the optical system, a zoom lens for adjusting the focal length (angle of view) of the optical system 103, and the like. Movable members included in the optical system 103 are driven by a motor and an actuator included in a driving unit 102. The operations of the driving unit 102 are controlled by the control unit 101. The control unit 101 can obtain information related to a state of the optical system 103 (e.g., the position of the focusing lens, the F-number, and the like) via a communication unit 104.

The optical system 103 forms an optical image of a subject on an imaging plane of the imaging unit 105. The imaging unit 105 may be, for example, a known CCD or CMOS color image sensor that includes color filters based on the primary-color Bayer arrangement.

The imaging unit 105 includes a pixel array in which a plurality of pixels are two-dimensionally arrayed, and peripheral circuits for reading out signals from each pixel. Each pixel accumulates charges corresponding to the amount of incident light by way of photoelectric conversion. A signal with a voltage corresponding to the amount of charges accumulated in an exposure period is read out from each signal; as a result, a group of pixel signals (analog image signals) representing a subject image formed on the imaging plane is obtained. The analog image signals are supplied to the image processing unit 109. The operations of the imaging unit 105 are controlled by the control unit 101.

The imaging unit 105 is also configured to be movable on a plane perpendicular to the optical axis of the optical system 103 by a predetermined amount in each of the horizontal and vertical directions, and the clockwise and counterclockwise directions around the optical axis. The control unit 101 can control the position of the imaging unit 105 by controlling driving members included in the driving unit 102, such as the motor. The position of the imaging unit 105 is controlled to realize a function of correcting an optical image blur and a function of generating a high-resolution image.

The communication unit 104 is a communication interface between the control unit 101 and the optical system 103, for example.

A shake detection unit 106 outputs signals corresponding to a motion of the digital camera 100. The shake detection unit 106 can include a gyroscope that detects the angular velocities around respective axes of a three-dimensional Cartesian coordinate system including an axis in the gravity direction and an axis in the optical axis direction, and an acceleration sensor that detects accelerations in the respective axis directions.

The image processing unit 109 applies image processing to the analog image signals output from the imaging unit 105 or image data that has been read from a recording medium 111 into the RAM 108, thereby generating signals and image data that suit an intended use, and obtaining and/or generating various types of information. The image processing unit 109 may be, for example, a dedicated hardware circuit that has been designed to realize specific functions, such as an application specific integrated circuit (ASIC). The image processing unit 109 outputs information and data that have been obtained or generated to the control unit 101 and the RAM 108 in accordance with an intended use.

The image processing applied by the image processing unit 109 can include, for example, preprocessing, color interpolation processing, correction processing, detection processing, data editing processing, evaluation value calculation processing, special effects processing, and so forth.

The preprocessing can include A/D conversion, noise reduction, signal amplification, reference level adjustment, defective pixel correction, and so forth. The color interpolation processing is processing which is executed in a case where the imaging unit 105 includes color filters, and which interpolates values of color components that are not included in the individual pieces of pixel data that compose image data. The color interpolation processing is also referred to as demosaicing processing.

The correction processing can include such processing as white balance adjustment, tone correction, correction of image deterioration caused by optical aberration of the optical system 103 (image recovery), correction of the influence of vignetting of the optical system 103, and color correction. The color interpolation processing and the correction processing may be collectively referred to as development processing.

The detection processing can include detection of a characteristic area (a face area, a human body area, or the like) and a motion therein, processing for recognition of a person, and so forth.

The data editing processing can include such processing as cutout of an area (cropping), composition, scaling, encoding and decoding, and generation of header information (generation of a data file). The data editing processing also includes generation of image data for display and image data for recording. The data editing processing further includes generation of a high-resolution image, which will be described later.

The evaluation value calculation processing can include such processing as generation of signals and evaluation values used in automatic focus detection (AF), and generation of evaluation values used in automatic exposure control (AE).

The special effects processing can include such processing as addition of blur effects, alteration of shades of colors, relighting, and so forth.

Note that these are examples of processing that can be applied by the image processing unit 109, and are not intended to limit processing applied by the image processing unit 109. A part of the processing listed above may be carried out as a result of the execution of the program by the control unit 101.

In the present embodiment, the image processing unit 109 performs a first resolution increase whereby a high-resolution image is generated by combining a plurality of frames of low-resolution images that have positional differences (that differ in viewpoint or observing point) from one another. The plurality of frames of low-resolution images include a reference frame and frames that have a specific amount of positional difference relative to the viewpoint (observing point) of the reference frame in a specific direction. Furthermore, the image processing unit 109 performs a second resolution increase whereby one frame of low-resolution image is converted into a high-resolution image. Each of the first and second resolution increases can be performed using any known method.

For example, a method described in Japanese Patent Laid-Open No. 2012-226489, a method that increases the pixel density by inserting pixels at positions corresponding to positional differences, or the like can be used as the first resolution increase. On the other hand, a (ML-based) method that uses a trained machine learning (ML) model or a (non-ML-based) method that does not use a machine learning model can be used as the second resolution increase. Non-ML-based methods include, but are not limited to, a nearest neighbor method, a bilinear method, a bicubic method, etc.

As the first resolution increase can achieve advantageous effects similar to those achieved by reducing a pixel pitch of the image sensor, the first resolution increase enables generation of high-resolution images with higher quality than the second resolution increase, as long as the optical resolution limit is not exceeded.

In a case where an ML-based method is used as the second resolution increase, the image processing unit 109 is provided with a trained machine learning model that has been configured to increase the resolution of an input image of a specific size at a predetermined rate and output the resultant image. The machine learning model can be implemented by using, for example, a two-dimensional convolutional neural network (CNN). Note that such a machine learning model can be realized by training the CNN using pieces of training data that include a high-resolution image as ground truth data, and a low-resolution image generated from the high-resolution image as input data. Note that the machine learning model may be realized based on any other known configurations and methods.

A display unit 110 is provided on, for example, a surface of a housing of the digital camera 100, and displays images that have been captured or reproduced, information of the digital camera 100, graphical user interfaces, and the like. The display unit 110 may be a liquid crystal or organic EL display. Parallel and continuous execution of shooting of moving images and display of the shot moving images allows the display unit 110 to function as an electronic viewfinder (EVF). An operation of causing the display unit 110 to function as the EVF is referred to as live-view display, and moving images that are displayed as live-views are referred to as live-view images.

The recording medium 111 is used as a destination of recording of a data file that stores data of an image captured by the imaging unit 105, an image processed by the image processing unit 109, or the like. The recording medium 111 may be a memory card that is attachable to and detachable from the digital camera 100, a nonvolatile memory built in the digital camera 100, or the like.

An operation unit 112 is a general term for input devices (buttons, switches, dials, etc.) that are provided for a user to input various types of instructions to the digital camera 100. Also, the operation unit 112 may include, for example, a zoom ring, a focus ring, and the like mounted on a lens barrel that houses the optical system 103.

The input devices that compose the operation unit 112 have names corresponding to the functions assigned thereto. For example, the operation unit 112 includes a release switch, a moving image recording switch, a shooting mode selection dial for selecting a shooting mode, a menu button, direction keys, a determination key, and so forth. The release switch is a switch for recording a still image; the control unit 101 recognizes a state where the release switch is pressed halfway down as a shooting preparation instruction, and a state where the release switch is fully pressed down as a shooting start instruction. Also, the control unit 101 recognizes depression of the moving image recording switch in a shooting standby state as an instruction for starting recording of moving images, and recognizes depression of the moving image recording switch during recording of moving images as an instruction for stopping recording. Note that the functions assigned to the same input device may be variable. Furthermore, the input devices may be software buttons or keys that use a touch display. In addition, the operation unit 112 may include input devices that support contactless input methods, such as voice input and line-of-sight input.

Next, processing for generating a high-resolution image according to the present embodiment will be described. As described above, the processing for generating a high-resolution image is executed by the image processing unit 109. Note that the generation of a high-resolution image can be executed in a case where, for example, a shooting mode for generating a high-resolution image (a super-resolution mode) has been set. In a case where the super-resolution mode has been set, the control unit 101 executes shooting of a plurality of frames of low-resolution images to be used in the first resolution increase. The image processing unit 109 generates one frame of high-resolution image using the plurality of frames of low-resolution images that have been shot. Note that the generation of the high-resolution image may be executed immediately after the shooting of the plurality of frames of low-resolution images, or may be executed with respect to a plurality of frames of low-resolution images that have been recorded in the recording medium 111 in advance.

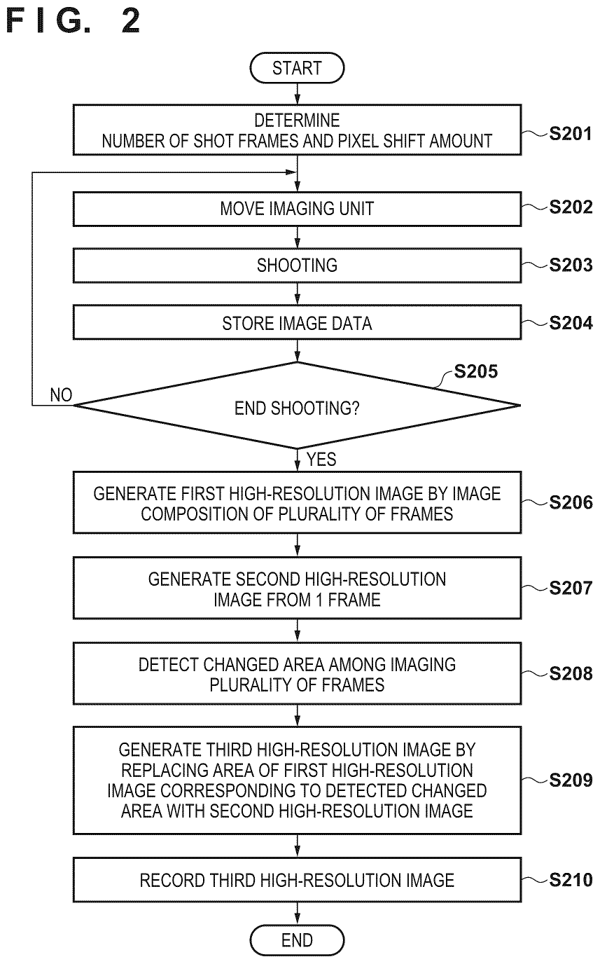

FIG. 2 is a flowchart related to the operations executed by the digital camera 100 when a shooting start instruction for a still image has been detected in a state where the super-resolution mode has been set. The shooting start instruction for the still image may be detection of full depression of the release switch, or may be expiration of a standby period of a self-timer. Note, it is assumed that the control unit 101 has executed processing for determining the shooting conditions (F-number, shutter speed, and shooting sensitivity) (AE) and processing of automatic focus detection (AF) of the optical system 103 upon detection of a shooting preparation instruction prior to detection of the shooting start instruction. Note that the shooting conditions may be values that have been set by the user. Also, the focusing distance of the optical system 103 may also be set by the user manually.

In step S201, the control unit 101 determines the number of shot frames and a pixel shift amount for low-resolution images (first images) that serve as the bases for a high-resolution image (second image). Note that a low resolution (first resolution) means an image that has a small number of pixels compared to a resolution (second resolution) of a composite image to be generated ultimately. In practice, it may be a still image with the highest resolution at which the imaging unit 105 can perform image capture.

The number of shot frames may be a predetermined fixed value, or may be able to be selected by the user from among a plurality of options (e.g., 3, 5, and 9). It is assumed here that nine frames are shot as one example.

The pixel shift amount, which is intended to achieve different viewpoints (observing points), can be determined using various methods. It may be a fixed value, or may be a value corresponding to the number of shot frames. In a case where the pixel density is increased by way of composition, the pixel shift amount has a value representing a smaller scale than the pixel pitch. The pixel pitch is a distance between the centers of neighboring pixels; it is assumed here that the pixel pitch is the same in the horizontal direction and the vertical direction. It is also assumed that the pixel shift amount is the pixel pitch/2 in both of the horizontal direction and the vertical direction as one example.

The method of determining at least one of the number of shot frames and the pixel shift amount can change in accordance with what kind of method is used to combine the plurality of frames of low-resolution images and generate one frame of high-resolution image.

Note that, here, the imaging unit 105 is moved to cause the low-resolution images to have different viewpoints under the premise that the digital camera 100 is affixed to a tripod or the like. However, the plurality of frames of low-resolution images with different viewpoints may be shot by utilizing motions of the digital camera 100, such as camera shakes. Furthermore, although it is assumed here that the plurality of frames of low-resolution images are shot using a function of continuous shooting of still images, it is permissible to shoot moving images and use one frame of the moving images as a low-resolution image. In a case where moving images are shot, the frame rate can be determined in view of a period required to move the imaging unit 105.

From step S202 to step S205, the control unit 101 executes processing for shooting low-resolution images corresponding to the determined number of frames.

In step S202, the control unit 101 moves the imaging unit 105 (image sensor) by controlling the driving unit 102 so as to realize the pixel shift amount corresponding to the frames. It is assumed that the direction of movement of the imaging unit 105 has been determined in advance for each frame in accordance with the number of shot frames. Note that a reference frame (e.g., the first frame) is shot without moving the imaging unit 105.

Here, in order to shoot nine frames, the control unit 101 for example moves the imaging unit 105 as follows in shooting of each frame. Consequently, nine frames of low-resolution images with different viewpoints are obtained.
First frame: no movement
Second frame: pixel pitch/2 in the rightward direction
Third frame: pixel pitch/2 in the leftward direction
Fourth frame: pixel pitch/2 in the upward direction
Fifth frame: pixel pitch/2 in the downward direction
Sixth frame: pixel pitch/2 in the rightward direction, pixel pitch/2 in the upward direction
Seventh frame: pixel pitch/2 in the rightward direction, pixel pitch/2 in the downward direction
Eighth frame: pixel pitch/2 in the leftward direction, pixel pitch/2 in the upward direction
Ninth frame: pixel pitch/2 in the leftward direction, pixel pitch/2 in the downward direction

When moving of the imaging unit 105 has been completed, the control unit 101 executes step S203.

In step S203, the control unit 101 executes shooting of one frame of still image by controlling the optical system 103 and the imaging unit 105.

In step S204, the control unit 101 reads out analog image signals from the imaging unit 105. The image processing unit 109 applies A/D conversion to the analog image signals, and stores the resultant signals into the RAM 108. At this point, the image processing unit 109 does not execute processing for increasing the resolution.

In step S205, the control unit 101 determines whether shooting of the number of frames determined in step S201 is finished; if the shooting has been determined to be finished, step S206 is executed, whereas if the shooting has not been determined to be finished, step S202 is executed.

In step S206, the control unit 101 instructs the image processing unit 109 to execute generation of a high-resolution image. In response to the instruction from the control unit 101, the image processing unit 109 performs the first resolution increase with respect to pieces of low-resolution image data corresponding to the plurality of frames stored in the RAM 108.

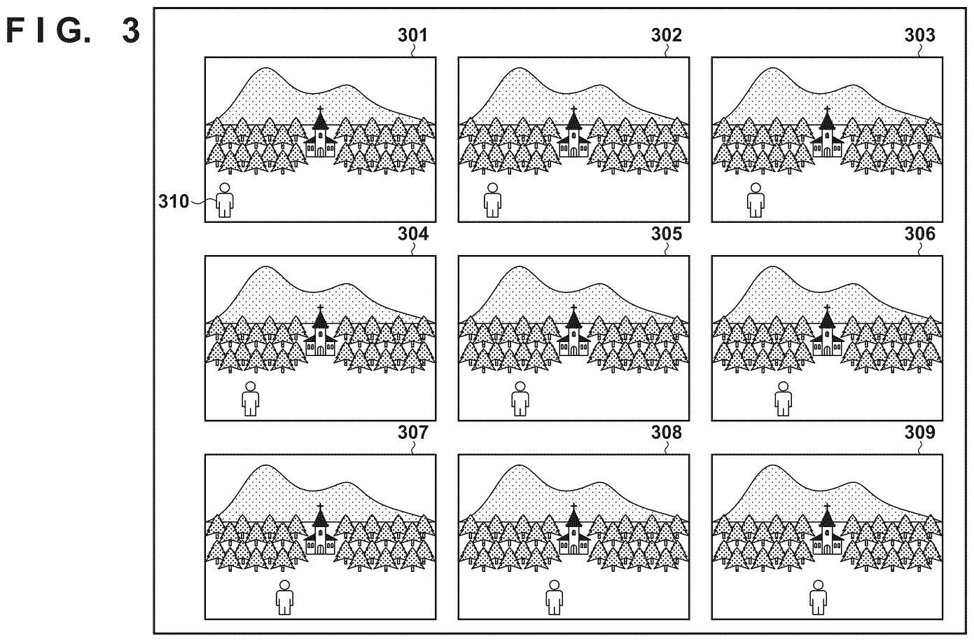

FIG. 3 shows examples of the pieces of low-resolution image data corresponding to the nine frames stored in the RAM 108, in the form of frame-by-frame images. 301 denotes an image of the first frame. In images 302 to 309 of the second and subsequent frames, the position of a human subject 310 has changed from the image of the first frame.

With use of the pieces of data of low-resolution images (first images) corresponding to the nine frames, the image processing unit 109 performs a first resolution increase that uses pixel insertion described in, for example, Japanese Patent Laid-Open No. 2012-226489, thereby generating data of one frame of first high-resolution image (second image). Note that the method of generating data of one frame of high-resolution image by combining pieces of low-resolution image data corresponding to a plurality of frames may be another known method.

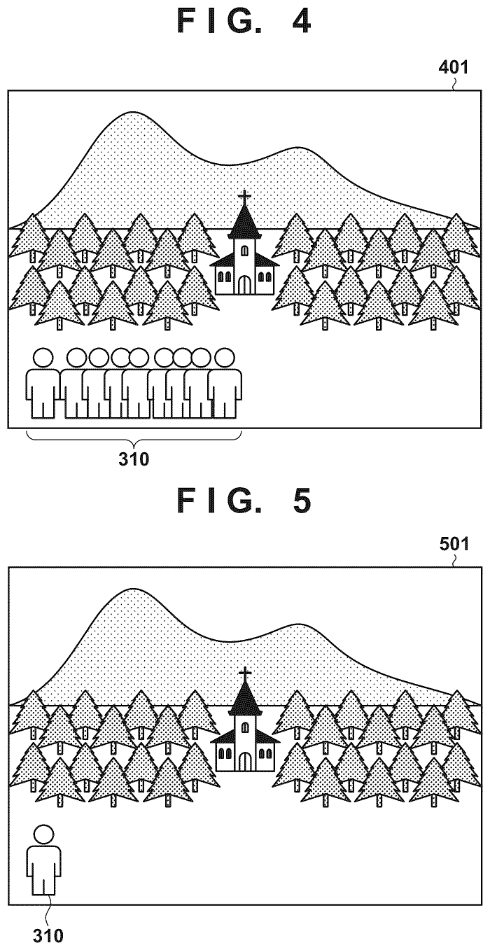

FIG. 4 schematically shows a first high-resolution image 401 generated by combining the low-resolution images 301 to 309 shown in FIG. 3. As shown in FIG. 4, the human subject 310, which changes in position in the plurality of frames of images to be combined, is a blurred image or overlapping images in the high-resolution image, which is a composite image. A similar problem arises also with respect to a subject that changes in shape in the plurality of frames of images to be combined.

The image processing unit 109 stores the data of the first high-resolution image generated through the first resolution increase into the RAM 108. Thereafter, the image processing unit 109 executes step S207.

In step S207, the image processing unit 109 performs the second resolution increase with respect to data of one frame of low-resolution image among the nine frames of low-resolution images (first images), thereby generating data of one frame of second high-resolution image (third image). It is assumed here that the second resolution increase uses a trained machine learning model that increases the resolution of an input image and outputs the resultant image. The second high-resolution image has the same resolution as the first high-resolution image. Note that the use of the machine learning model requires a large number of memories and computation resources. For this reason, one frame of low-resolution image may be divided into a plurality of blocks, and the resolution may be increased on a per-block basis. In this case, the second high-resolution image can be obtained by piecing (stitching) together the high-resolution images in the respective blocks.

It is assumed that the image to which the second resolution increase is applied is, for example, the image of the first frame. This is because the image of the first frame is considered to be an image intended by the user. However, the image of the second or subsequent frame may be used. Note that the second resolution increase may be performed based on a method that does not use the machine learning model.

FIG. 5 schematically shows a second high-resolution image 501 generated from the low-resolution image 301 shown in FIG. 3. As shown in FIG. 5, as one frame of image has been increased in resolution, the human subject 310 is not a blurred image or overlapping images. The image processing unit 109 stores data of the second high-resolution image generated through the second resolution increase into the RAM 108. Thereafter, the image processing unit 109 executes step S208.

In step S208, the image processing unit 109 detects an area that exhibits changes among the plurality of frames of low-resolution images (a changed area). While the changed area can be detected using various methods, the following describes a method that uses the first high-resolution image and the second high-resolution image. The first high-resolution image is a composite image that has been generated using the nine frames of low-resolution images. On the other hand, the second high-resolution image is an image that has been generated using one frame of low-resolution image. Therefore, in an image of differences between the first high-resolution image and the second high-resolution image, an area in which the absolute values of differences are equal to or larger than a certain value is regarded as a changed area. The differences may be obtained on a per-pixel basis, or may be obtained on a per-block basis. Also, the difference image may be obtained for each of color planes of the color filters. Furthermore, the differences between elements other than luminance values may be obtained.

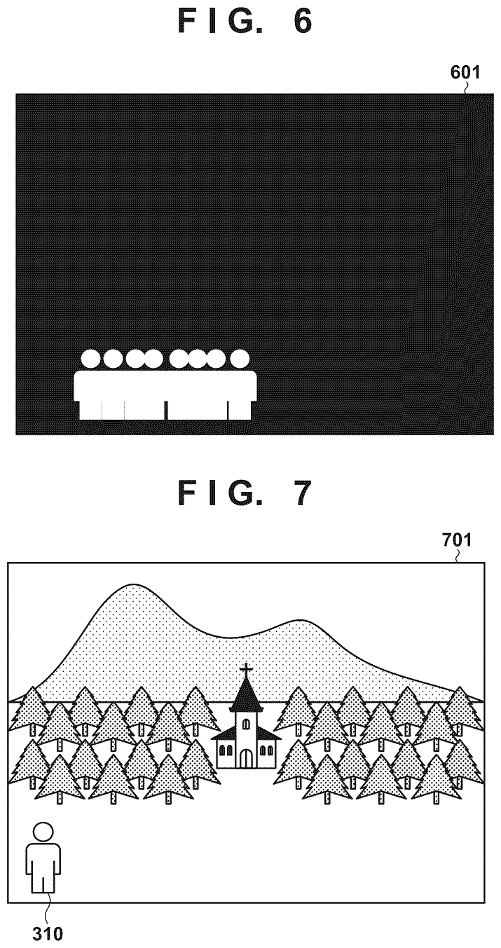

FIG. 6 shows an example of a changed area map 601 obtained by binarizing a difference image with an application of a threshold, the difference image being obtained by yielding absolute values of luminance value differences between the first high-resolution image 401 shown in FIG. 4 and the second high-resolution image 501 shown in FIG. 5 on a per-pixel basis. Note that the threshold can be, for example, experimentally obtained in advance and stored into the ROM 107 or the image processing unit 109.

In the changed area map 601, a black portion is an area in which the differences are smaller than the threshold and no change has occurred. On the other hand, a white portion is a changed area in which the differences are equal to or larger than the threshold. It can be said that the changed area map 601 is an image indicating the position at which the changed area exists in the first high-resolution image.

The image processing unit 109 stores the generated changed area map 601 into the RAM 108. Thereafter, the image processing unit 109 executes step S209.

In step S209, the image processing unit 109 generates a third high-resolution image (fourth image) from the first high-resolution image (second image) and the second high-resolution image (third image) based on the changed area detected in step S208. Specifically, the image processing unit 109 generates the third high-resolution image by replacing an area of the first high-resolution image corresponding to the detected changed area with the second high-resolution image. The third high-resolution image is a high-resolution image that is generated ultimately. The image processing unit 109 cuts out an area corresponding to the changed area from the second high-resolution image while using the changed area map 601 as a mask, for example. Then, the image processing unit 109 replaces an area of the first high-resolution image corresponding to the changed area with the image that has been cut out.

Alternatively, the third high-resolution image can be generated also by selecting the first high-resolution image for the black area in the changed area map 601, and selecting the second high-resolution image for the white area therein.

FIG. 7 shows an example of a third high-resolution image 701 that has been generated from the first high-resolution image 401 and the second high-resolution image 501 with use of the changed area map 601. An appropriate high-resolution image has been obtained without blurring or overlapping of the human subject 310.

As described above, the first high-resolution image has higher quality than the second high-resolution image. Therefore, replacing only a portion of the first high-resolution image corresponding to the changed area with the second high-resolution image yields the third high-resolution image which has higher quality than the second high-resolution image, and which includes no defects in an area that exhibits changes among the plurality of frames of low-resolution images.

Note that the smaller the area replaced with the second high-resolution image, the more advantageous in terms of image quality; however, a processing load related to generation of the third high-resolution image may be reduced by simplifying the changed area. For example, a rectangular area in which the changed area is inscribed may be the area to be replaced with the second high-resolution image.

The image processing unit 109 stores data of the generated third high-resolution image into the RAM 108. Thereafter, the image processing unit 109 executes step S210.

In step S210, the image processing unit 109 generates a data file storing the data of the third high-resolution image, and records the data file into the recording medium 111. Note that in a case where the digital camera 100 can communicate with an external apparatus, the data file may be output to the external apparatus.

Although it is assumed here that only the data of the third high-resolution image is recorded, at least one of the data of the first high-resolution image and the data of the second high-resolution image may be recorded as well. Furthermore, although the foregoing description is related to a case where the high-resolution image is recorded as data in a RAW format, it may be recorded after the image processing unit 109 has executed such image processing as development processing and encoding processing therefor.

### Modification Examples

A description is now given of a modification example of the processing for detecting a changed area in step S208. A changed area may be detected using low-resolution images instead of using the first and second high-resolution images. Specifically, the image processing unit 109 may detect a changed area based on images of differences among the plurality of frames of low-resolution images obtained in the processing of steps S202 to S205.

For example, the image processing unit 109 holds the image of the first frame as a reference image in the RAM 108, and generates, for each of the images of the second and subsequent frames, an image of differences from the image of the first frame. The image processing unit 109 can generate the changed area map 601 shown in FIG. 6 by applying a threshold to a summated difference image obtained by summating the difference images for the eight frames, or to a difference image obtained by dividing the summated difference image by the number of frames (8). Note that in a case where the changed area map 601 is generated from the low-resolution images, the image processing unit 109 uses the changed area map 601 after enlarging it to the same resolution as a high-resolution image in step S209. Alternatively, the difference images may be generated after enlarging the low-resolution images to the same resolution as a high-resolution image. The second resolution increase can be used in these types of enlargement. As the changed area map 601 is a binary image, the non-ML-based method with simple processing is used in a case where the changed area map 601 is enlarged.

Note that in a case where a changed area is detected from the low-resolution images, the difference images may be generated while executing the processing of steps S202 to S205. In this case, the changed area may be detected by executing step S208 before generating the first high-resolution image in step S206.

According to the present embodiment, out of one frame of first high-resolution image obtained by combining a plurality of frames of low-resolution images, an area that exhibits changes among the plurality of frames of low-resolution images is replaced with a high-resolution image obtained from one frame of low-resolution image. Therefore, a high-resolution image can be obtained which has higher quality in an unchanged area, and which includes no defects in a changed area.

Note that the image quality can be improved by using a high-resolution image obtained from one frame of low-resolution image, even without completely replacing the area that exhibits changes among the plurality of frames of low-resolution images with a high-resolution image obtained from one frame of low-resolution image. For example, in the area that exhibits changes among the plurality of frames of low-resolution images, one frame of first high-resolution image obtained by combining the plurality of frames of low-resolution images may be combined with a high-resolution image obtained from one frame of low-resolution image. It is sufficient to set proportions in this combination in accordance with the extent of changes in the area that exhibits changes among the low-resolution images; it is sufficient that the proportion of a high-resolution image obtained from one frame of low-resolution image in the combination be larger when the extent of changes is large than when the extent of changes is small. In this way, by using an image based on a high-resolution image obtained from one frame of low-resolution image in the area that exhibits changes among the plurality of frames of low-resolution images, the image quality can be improved compared to a case where the high-resolution image obtained from one frame of low-resolution image is not used.

### OTHER EMBODIMENTS

The above-described embodiment has been described in relation to a configuration in which the digital camera executes shooting of low-resolution images and generation of a high-resolution image as a processing sequence. However, a high-resolution image can be generated also by using low-resolution images that have already been recorded. Also, in a case where the low-resolution images that have already been recorded are used, an image capture function is not necessary. Accordingly, an electronic device not having an image capture function can also perform the above-described embodiment. In order to allow the above-described processing for generating a high-resolution image to be executed with use of the low-resolution images that have already been recorded, it is sufficient to record information indicating the amount and direction of pixel shift (information related to a viewpoint) in association with each of the plurality of frames of low-resolution images that have been shot. In this way, the first resolution increase can be performed appropriately. The second resolution increase can be performed with respect to, for example, a low-resolution image with the oldest recording time, or a low-resolution image with a pixel shift amount of 0.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-129515, filed Aug. 8, 2023, which is hereby incorporated by reference herein in its entirety.

What is claimed is:

1. An image processing apparatus comprising:
one or more processors that execute a program stored in a memory and thereby function as:
an obtainment unit that obtains a plurality of frames of first images, wherein the first images differ from each other in viewpoint;
a generation unit that generates one frame of second image having a higher resolution than the first images by combining the plurality of frames of first images, and generates a third image having a same resolution as the second image from one of the plurality of frames of first images; and
a detection unit that detects a changed area that has changed among the plurality of frames of first images,
wherein the generation unit further generates a fourth image, as a high-resolution image based on the plurality of frames of first images, from the second image and an area of the third image corresponding to an area of the second image corresponding to the changed area.

2. The image processing apparatus according to claim 1, wherein
the detection unit detects the changed area based on a difference between the second image and the third image.

3. The image processing apparatus according to claim 1, wherein
the detection unit detects the changed area based on differences among the plurality of frames of first images.

4. The image processing apparatus according to claim 3, wherein
the detection unit enlarges each of the plurality of frames of first images to the same resolution as the second image, and uses the enlarged plurality of frames of first images in the detection of the changed area.

5. The image processing apparatus according to claim 1, wherein
the generation unit generates the second image by combining the plurality of frames of first image so as to increase pixel density.

6. The image processing apparatus according to claim 1, wherein
the generation unit generates the third image from the one of the plurality of frames of first image with use of a machine learning model that has been trained to increase a resolution of an input image and output a resultant image.

7. The image processing apparatus according to claim 1, wherein
the generation unit generates the second image by combining the plurality of frames of first images with use of pieces of information related to viewpoints that have been recorded respectively in association with the plurality of frames of first images.

8. The image processing apparatus according to claim 1, wherein
the detection unit generates a change area map for to the plurality of frames of first images, the change area map having values that differ between the changed area and an unchanged area, and
the generation unit generates the fourth image from the second image and the third image based on the change area map.

9. The image processing apparatus according to claim 1, wherein
the generation unit generates the fourth image by replacing the area of the second image corresponding to the changed area with the area of the third image corresponding thereto.

10. An image processing method executed by an image processing apparatus, the image processing method comprising:
obtaining a plurality of frames of first images, wherein the first images differ from each other in viewpoint;
generating one frame of second image having a higher resolution than the first images by combining the plurality of frames of first images;
generating a third image having a same resolution as the second image from one of the plurality of frames of first images;
detecting a changed area that has changed among the plurality of frames of first images; and
generating a fourth image, as a high-resolution image based on the plurality of frames of first images, from the second image and an area of the third image corresponding to an area of the second image corresponding to the changed area.

11. An image capture apparatus, comprising:
an image sensor; and
an image processing apparatus, wherein the image processing apparatus comprising:
one or more processors that execute a program stored in a memory and thereby function as:
an obtainment unit that obtains a plurality of frames of first images, wherein the first images have been shot at different viewpoints with use of the image sensor;
a generation unit that generates one frame of second image having a higher resolution than the first images by combining the plurality of frames of first images, and generates a third image having a same resolution as the second image from one of the plurality of frames of first images; and
a detection unit that detects a changed area that has changed among the plurality of frames of first images,
wherein the generation unit further generates a fourth image, as a high-resolution image based on the plurality of frames of first images, from the second image and an area of the third image corresponding to an area of the second image corresponding to the changed area.

12. The image capture apparatus according to claim 11, wherein the one or more processors of the image processing apparatus further function as a control unit that controls a position of the image sensor that causes the position of the image sensor to be different among times of shooting of the respective plurality of frames of first images.

13. The image capture apparatus according to claim 11, wherein
the image capture apparatus records the fourth image generated by the image processing apparatus.
